(19) United States
(12) Patent Application Publication
(10) Pub. No.: US 2014/0334045 A1
(43) Pub. Date: Nov. 13, 2014

(54) CIRCUIT AND A METHOD FOR ELECTROSTATIC DISCHARGE PROTECTION

(71) Applicant: BEKEN CORPORATION, Shanghai (CN)

(72) Inventors: Peng Han, Shanghai (CN); Jiazhou Liu, Shanghai (CN); Qunshan Xu, Shanghai (CN)

(21) Appl. No.: 13/911,093

(22) Filed: Jun. 6, 2013

(30) Foreign Application Priority Data
May 8, 2013 (CN) 201310167397.9

(51) Int. Cl. H02H 9/04

(52) U.S. Cl. CPC H02H 9/04
USPC 361/56

(57) ABSTRACT

An electrostatic discharge (ESD) protection device for use with a power amplifier, the power amplifier having an output port being a collector of a first transistor, wherein the ESD protection device comprises a second transistor having a first terminal connected to the collector of the first transistor, a second terminal connected to ground via a resistor, and a third terminal connected to the ground, such that the second transistor can discharge electrostatic on the output port.

### CLAIM OF PRIORITY

This application claims priority to Chinese Application No. 201310167397.9 entitled “A CIRCUIT AND A METHOD FOR ELECTROSTATIC DISCHARGE PROTECTION”, filed on May 8, 2013 by Beken Corporation, which is incorporated herein by reference.

### TECHNICAL FIELD

The present application relates to electrostatic discharge protection, and more particularly but not limited to a circuit and method for electrostatic discharge protection.

### BACKGROUND

Electrostatic discharge (ESD) is a sudden flow of electricity between two objects. ESD can cause a range of harmful effects in industry, including failure of solid state electronics components such as integrated circuits.

There are typically three types of causes of ESD: ESD caused by various kinds of machine, ESD caused by movement of electrical devices, and ESD caused by contact with human body. Electrical products are subject to severe ESD damages during use. In particular, the interfaces, such as input and output port of power amplifier, are easily damaged by ESD.

Accordingly, a new ESD protection circuit and a method of use are desirable.

### SUMMARY OF THE INVENTION

In an embodiment, there is provided a circuit comprising an electrostatic discharge (ESD) protection device and a power amplifier, the power amplifier having an output port including a collector of a first transistor, wherein the ESD protection device comprises: a second transistor having a first terminal connected to the collector of the first transistor, a second terminal connected to ground via a resistor, and a third terminal connected to the ground, such that the second transistor can discharge electrostatic electricity on the output port.

In another embodiment, there is provided a circuit with electrostatic discharge (ESD) protection, the circuit having a power amplifier input port and a power amplifier output port including a collector of a first transistor, wherein: the circuit comprises a first power supply and a first ground for providing power to the power amplifier input port, and a second power supply and a second ground for providing power to the power amplifier output port, wherein the circuit further comprises a second transistor having a first terminal connected to the collector of the first transistor, a second terminal connected to the second ground via a first resistor, and a third terminal connected to the second ground, such that the second transistor can discharge electrostatic electricity on the output port.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows a schematic diagram of a power amplifier according to an embodiment of the invention.

FIG. 2 shows a circuit according to an embodiment of the invention.

FIG. 2A shows a circuit according to another embodiment of the invention.

FIG. 2B shows a circuit according to another embodiment of the invention.

FIG. 3 shows a flowchart of a method according to an embodiment of the invention.

FIG. 4 shows a circuit according to an embodiment of the invention.

FIG. 4A shows a circuit according to another embodiment of the invention.

FIG. 4B shows a circuit according to another embodiment of the invention.

### DETAILED DESCRIPTION OF THE ILLUSTRATED EMBODIMENTS

Various aspects and examples of the invention will now be described. The following description provides specific details for a thorough understanding and enabling description of these examples. Those skilled in the art will understand, however, that the invention may be practiced without many of these details. Additionally, some well-known structures or functions may not be shown or described in detail, so as to avoid unnecessarily obscuring the relevant description.

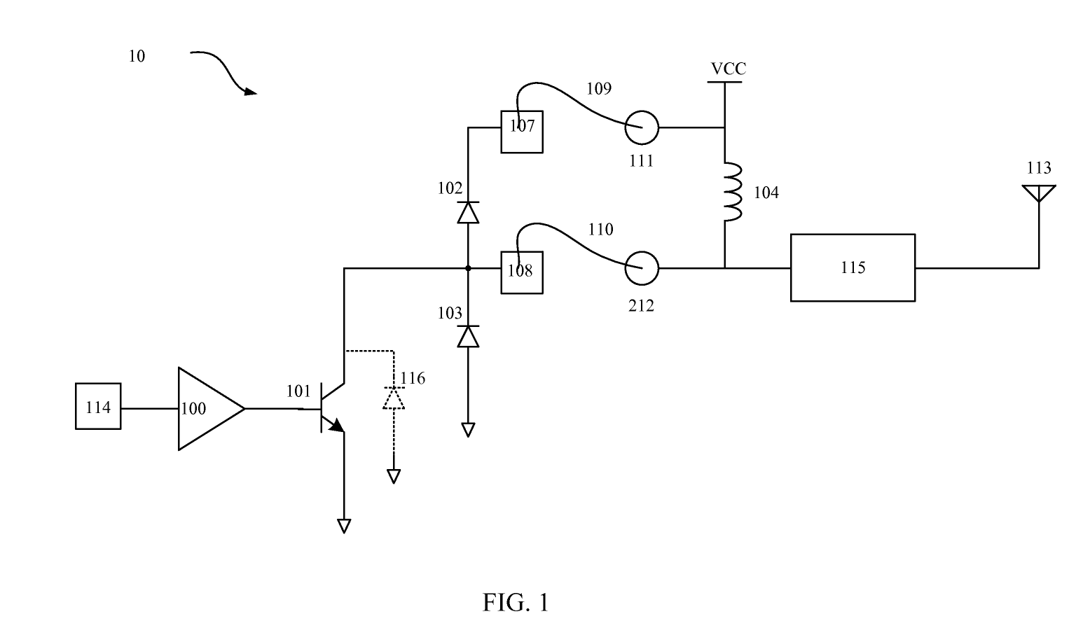

FIG. 1 shows a schematic diagram of a power amplifier. The power amplifier circuit 10 is packaged into an integrated circuit (IC, not shown in FIG. 1), and the IC is communicatively coupled to a printed circuit board, for example, the IC is DC (direct current) coupled to a printed circuit board (PCB, not shown in FIG. 1). The power amplifier circuit 10 comprises an input port 114, a drive 100, a transistor 101, two diodes 102 and 103, and two output bonding pads 107 and 108 on the IC. The PCB further comprises an inductor 104, two bonding wires 109 and 110, and two pins 111 and 112 of the package, a matching network 115, and an antenna 113.

In the power amplifier circuit 10, input port 114 receives input signal, such as radio frequency (RF) signals, and the input port of the drive 100 is connected to the input port 114. The drive 100 amplifies the RF signal initially, and drives the transistor 101. The output port of the drive 100 is connected to the base of the transistor 101. The collector of the transistor 101 is connected to the anode of the diode 102, the cathode of the diode 103, and the output bonding pad 108. The cathode of the diode 102 is connected to the output bonding pad 107. The output bonding pad 107 is connected to the pin 111 via the bonding wire 109. The pin 111 is connected to both Vcc and a first terminal of the inductor 104. The output bonding pad 108 is connected to the pin 112 via the bonding wire 110. The pin 112 is connected to a second terminal of the inductor 104. The inductor 104 acts as a choke to provide operation current to the transistor 101. The bond wires may comprise materials such as Aluminum, Copper and/or Gold, etc. The output impedance of IC is usually small; therefore the matching network 115 is needed to convert the impedance to about 50 Ohm, and then connected to the antenna 113. The diode 116 is a parasitic diode in the transistor 101, which is formed between the collector of the transistor 101 and the substrate. The collector of the transistor 101 is the cathode of the parasitic diode 116, and the substrate is the anode of the parasitic diode 116.

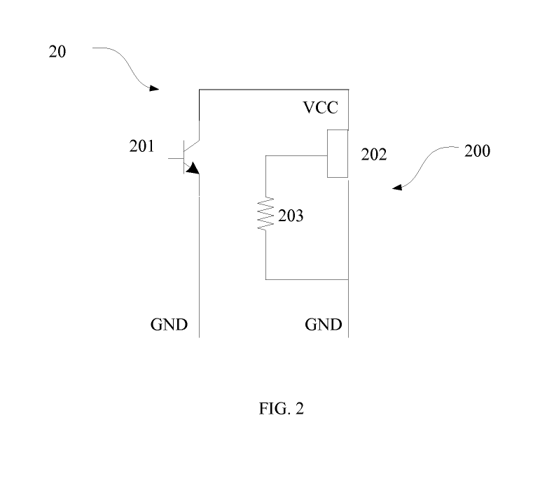

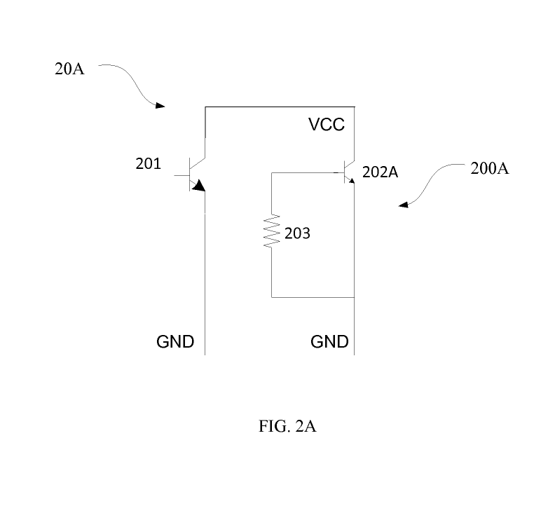

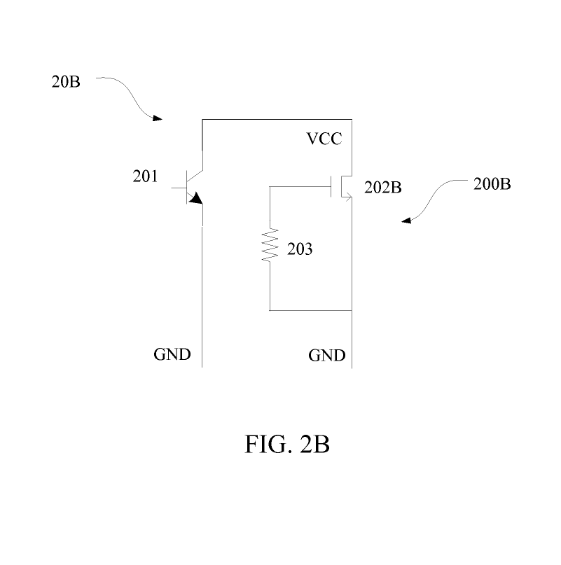

FIG. 2 shows a structure for protecting the output port of the power amplifier 20 according an embodiment of the present invention. A circuit 20 comprises an electrostatic discharge (ESD) protection device 200 and a power amplifier. The power amplifier includes an output port of the power amplifier. The output port of the power amplifier includes a collector of a first transistor 201. The ESD protection device 200 comprises a second transistor 202 having a first terminal connected to the collector of the first transistor 201, a second terminal connected to ground (GND) via a resistor 203, and a third terminal connected to the ground (GND), such that the second transistor 202 can discharge electrostatic electricity on the output port.

FIG. 2A shows a circuit according to another embodiment of the invention. As shown in FIG. 2A, the second transistor 202 includes a NPN Bi-Polar transistor 202A, the first terminal includes a collector, the second terminal includes a base and the third terminal includes an emitter. That is to say, the ESD protection device 200A comprises a NPN Bi-Polar transistor 202A having a collector connected to the collector of the first transistor 201, a base connected to ground via a resistor 203, and an emitter connected to the ground, such that the NPN Bi-Polar transistor 202A can discharge electrostatic electricity on the output port.

FIG. 2B shows a circuit according to another embodiment of the invention. As shown in FIG. 2B, in the circuit 20B, the ESD protection device 200B comprises the second transistor 202. The second transistor 202 includes a NMOS (Mental-Oxide-Semiconductor) transistor 202B. The first terminal includes a drain, the second terminal includes a gate and the third terminal includes a source. That is to say, the ESD protection device 200B comprises a NMOS transistor 202B having a drain connected to the collector of the first transistor 201, a gate connected to ground via a resistor 203, and a source connected to the ground, such that the NMOS transistor 202B can discharge electrostatic electricity on the output port. In FIG. 2A and FIG. 2B, same reference numbers refer to same components in the circuit as with FIG. 2.

The value of the resistor 203 is between about 2 kΩ to about 100 kΩ. It is known that the turn-on voltage of the NPN Bi-Polar transistor 202A is about 0.7v, and the turn-on current is of the magnitude of microampere, then the value of the resistor 203 may be chosen from between about 21 kΩ to about 100 kΩ. The turn-on voltage of the NMOS transistor 202B may be about 0.4V, and the turn-on current is of the magnitude of microampere, then the value of the resistor 203 may be chosen from between about 2 kΩ to about 100 kΩ when NMOS transistor 202B is used for ESD protection for the transistor 201.

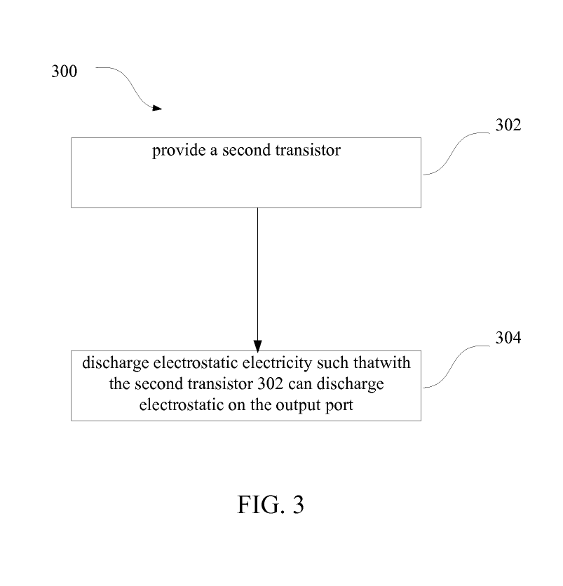

FIG. 3 shows a flowchart of a method 300 of electrostatic discharge (ESD) protection for a power amplifier, according to an embodiment of the invention. The power amplifier has an output port including a first transistor 201, the first transistor 201 having a base, a collector and an emitter.

As shown in FIG. 3, in block 302, the method provides a second transistor 202 having a first terminal connected to the collector of the first transistor 201, a second terminal connected to ground via a resistor, and a third terminal connected to the ground.

In block 304, the method comprises discharging electrostatic electricity on the output port with the second transistor 202.

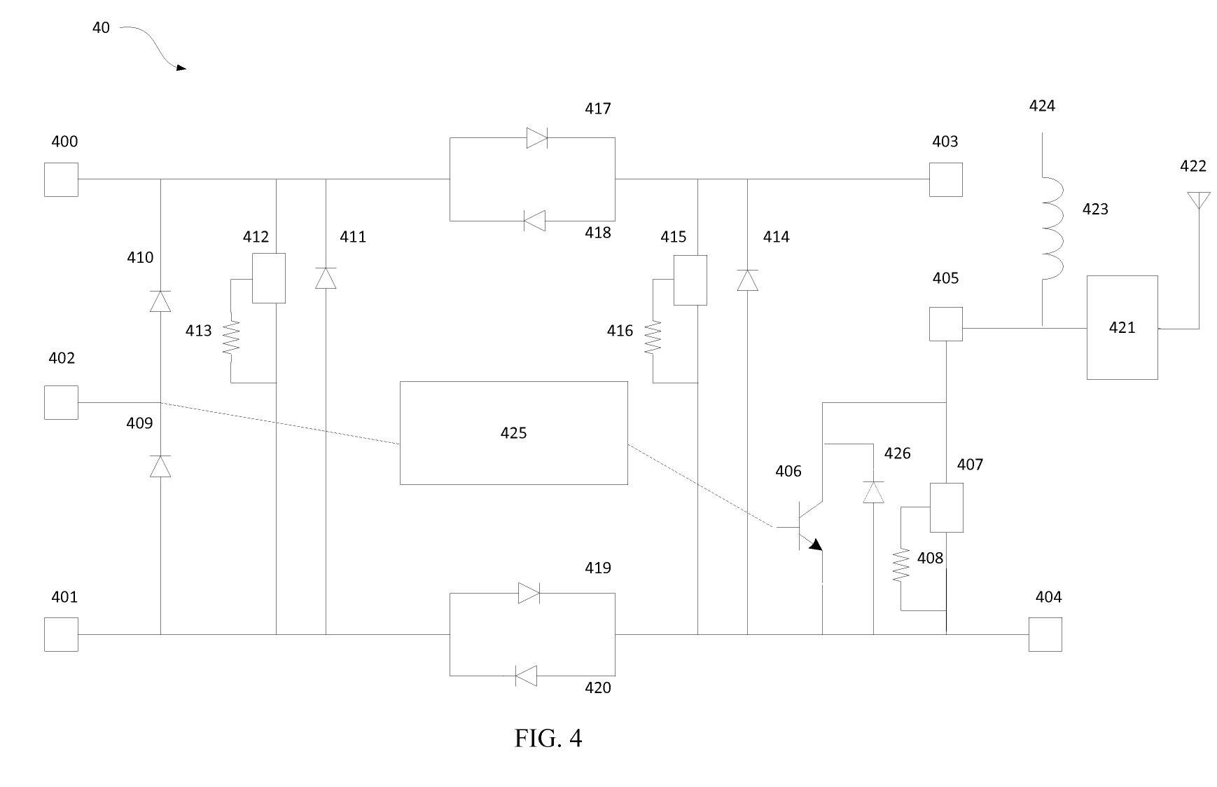

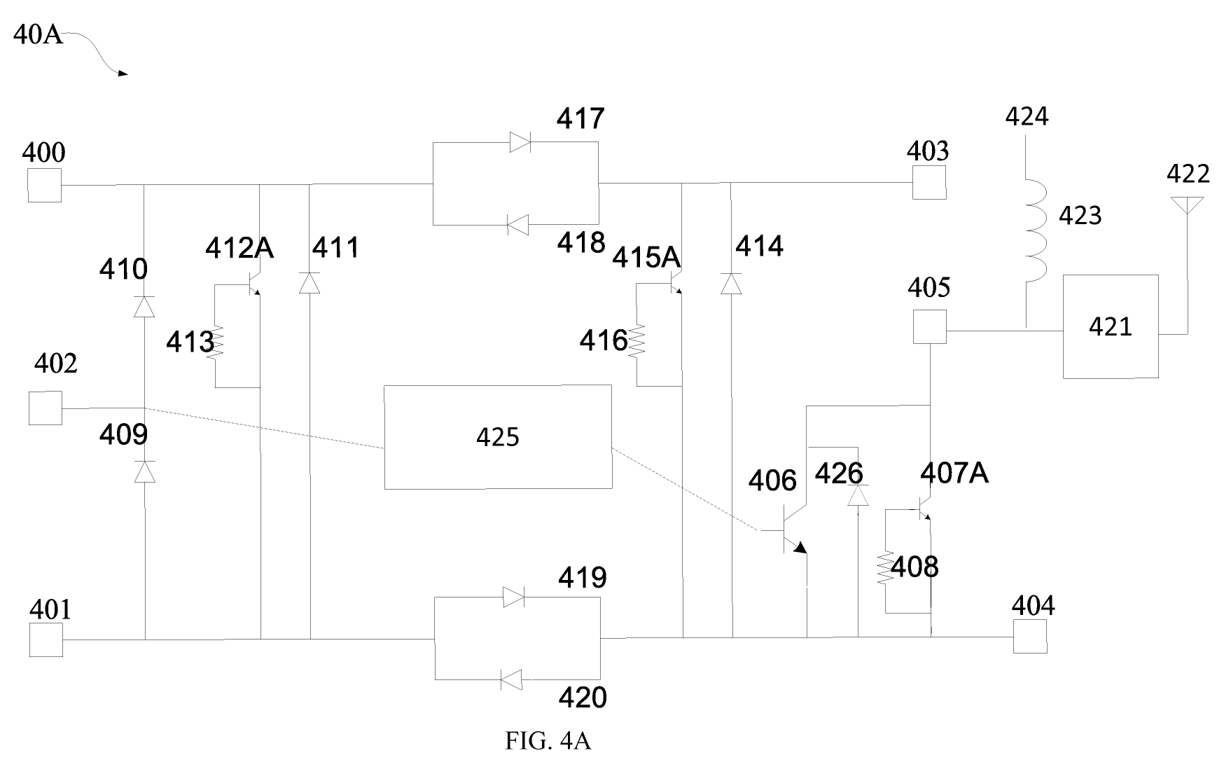

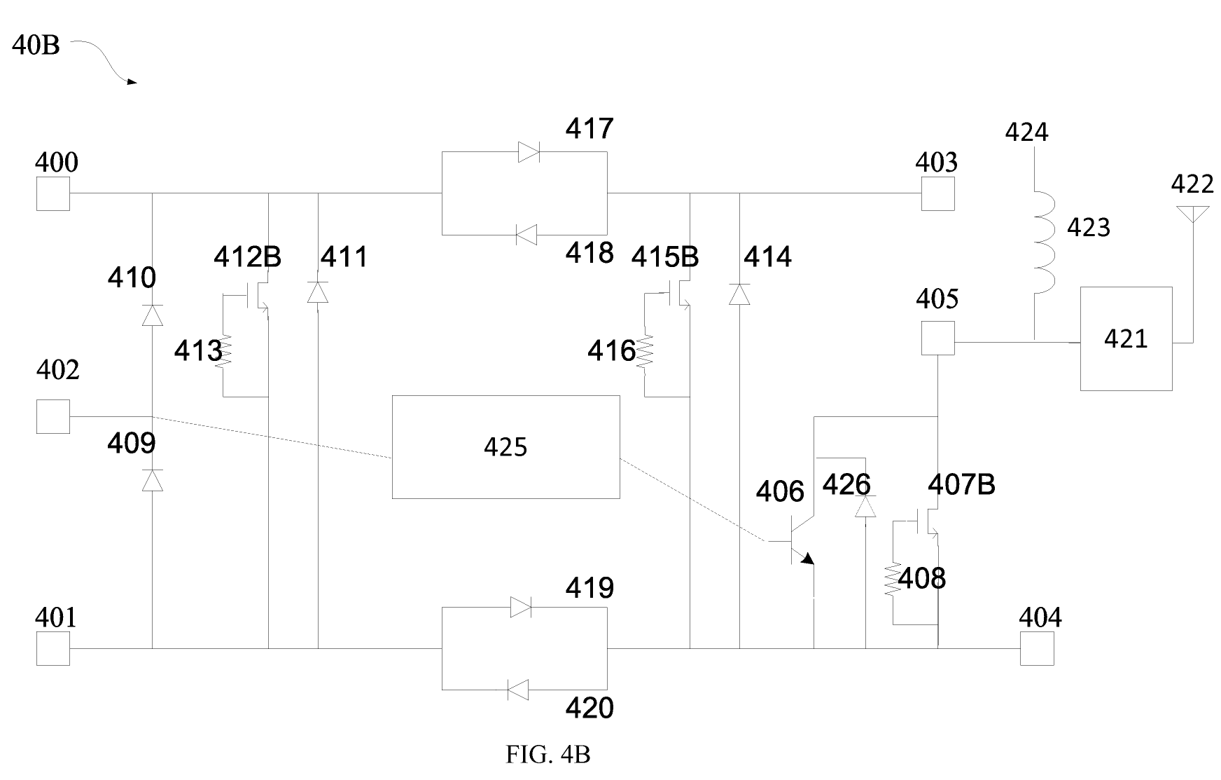

FIG. 4 shows a circuit 40 with electrostatic discharge (ESD) protection, the circuit 40 having a power amplifier input port and a power amplifier output port including a collector of a first transistor.

The circuit 40 comprises a first power supply Vcc 400 for providing power to the power amplifier input port 402 and a first ground 401, and a second power supply Vcc 403 for providing power to the power amplifier output port 405 and a second ground 404. The power amplifier output port 405 comprises a collector of a first transistor 406. The circuit 40 further comprises a second transistor 407 having a first terminal connected to the collector of the first transistor 406, a second terminal connected to the second ground 404 via a first resistor 408, and a third terminal connected to the second ground 404, such that the second transistor 407 can discharge electrostatic electricity on the output port.

The circuit 40 further comprises a matching network 421, an inductor 423, an antenna 422 and a third power supplier 424. These components are similar to those discussed in FIG. 1, therefore their descriptions are omitted here for simplicity. Diode 426 is a parasitic diode of transistor 406, similar to the diode 116 in FIG. 1. The circuit core 425 represents the internal circuit, and only power input port 402 and power output port 405 of the internal circuit are shown for simplicity.

FIG. 4A shows a circuit according to another embodiment of the invention. As shown in FIG. 4A, in the circuit 40A, the second transistor 407 includes a NPN Bi-Polar transistor 407A, the first terminal includes a collector, the second terminal includes a base and the third terminal includes an emitter. That is to say, the NPN Bi-Polar transistor 407A has a collector connected to the collector of the first transistor 406, a base connected to the second ground 404 via the first resistor 408, and an emitter connected to the second ground 404, such that the NPN Bi-Polar transistor 407A can discharge electrostatic electricity on the output port.

In another embodiment, as shown in FIG. 4B, in the circuit 40B, the second transistor 407 includes a NMOS (Mental-Oxide-Semiconductor) transistor 407B, the first terminal includes a drain, the second terminal includes a gate and the third terminal includes a source. That is to say, the NMOS transistor 407B has a drain connected to the collector of the first transistor 406, a gate connected to the second ground 404 via the first resistor 408, and a source connected to the second ground 404, such that the NMOS transistor 407B can discharge electrostatic electricity on the output port.

Alternatively, the circuit 40 may further comprise a first diode 409 connected between the power amplifier input port 402 and the first ground 401, and a second diode 410 connected between the power amplifier input port 402 and the first power supply 400.

As shown in FIG. 4, the anode of the first diode 409 is connected to the first ground 401, and the cathode of the first diode 409 is connected to the power amplifier input port 402. The anode of the second diode 410 is connected to the power amplifier input port 402, and the cathode of the second diode 410 is connected to the first power supply 400.

The first diode 409 and the second diode 410 together provide electrostatic protection for the power amplifier input port 402. The electrostatic electricity on the power input port 402 can be discharged via the first ground 401 when a negative voltage is applied to the power input port 402, and the electrostatic electricity on the power input port 402 can be discharged via the Vcc 400 when a positive voltage is applied to the power input port 402. Since the electrostatic electricity on the power input port 402 can be discharged, the power input port 402 is protected from ESD damage.

Alternatively, the circuit 40 may further comprise a third diode 411 connected between the first power supply 400 and the first ground 401, and a third transistor 412 with a fourth terminal connected to the first power supply 400, a fifth terminal connected to the first ground 401 via a second resistor 413, and a sixth terminal connected to the first ground 401.

An anode of the third diode 411 is connected to the first ground 401 and a cathode of the third diode 411 is connected to the first power supply Vcc 400. The third diode 411 is configured to provide channel for discharging electrostatic electricity from the first ground 401 to the first power supply Vcc 400. The third transistor 412 is used between the first power supply Vcc 400 to the first ground 401 to discharge the electrostatic electricity. Since dropout voltage exists between the first power supply Vcc 400 to the first ground 401, the third transistor 412 is used to ensure that the third transistor 412 is not on during normal active operation status, and the third transistor 412 is on only when electrostatic electricity passes through the third transistor 412.

In one embodiment, as shown in FIG. 4A, the third transistor 412 includes a NPN Bi-Polar transistor, the fourth terminal includes a collector, the fifth terminal includes a base and the sixth terminal includes an emitter. That is to say, the third transistor 412 comprises a NPN Bi-Polar transistor 412A having a collector connected to the first power supply Vcc 400, a base connected to the first ground 401 via a second resistor 413, and an emitter connected to the first ground 401, such that the NPN Bi-Polar transistor 412A can discharge electrostatic electricity on the first power supply Vcc 400.

In an alternative embodiment, the third transistor 412 includes a NMOS transistor, the fourth terminal includes a drain, the fifth terminal includes a gate and the sixth terminal includes a source. That is to say, the third transistor 412 comprises a NMOS transistor 412B having a drain connected to the first power supply Vcc 400, a gate connected to the first ground 401 via the second resistor 413, and a source connected to the first ground 401, such that the NMOS transistor 412B can discharge electrostatic electricity on the first power supply Vcc 400.

Alternatively, the circuit 40 further comprises a fourth diode 414 connected between the second power supply Vcc 403 and the second ground 404, and a fourth transistor 415 with a seventh terminal connected to the second power supply Vcc 403, an eighth terminal connected to the second ground 404 via a third resistor 416, and a ninth terminal connected to the second ground 404.

An anode of the fourth diode 414 is connected to the second ground 404 and a cathode of the fourth diode 414 is connected to the second power supply Vcc 403. The fourth diode 414 is configured to provide channel for discharging electrostatic electricity from the second ground 404 to the second power supply Vcc 403.

The fourth transistor 415 is used between the second power supply Vcc 403 to the second ground 404 to discharge the electrostatic electricity. Since dropout voltage exists between the second power supply Vcc 403 to the second ground 404, the fourth transistor 415 is used to ensure that the fourth transistor 415 is not on during normal active operation status, and the fourth transistor 415 is on only when electrostatic electricity passes through the fourth transistor 415.

In one embodiment, the fourth transistor 415 includes a NPN Bi-Polar transistor, the seventh terminal includes a collector, the eighth terminal includes a base and the ninth terminal includes an emitter. That is to say, as shown in FIG. 4A, the fourth transistor 415 comprises a NPN Bi-Polar transistor 415A having a collector connected to the second power supply Vcc 403, a base connected to the second ground 404 via the third resistor 416, and an emitter connected to the second ground 404, such that the NPN Bi-Polar transistor 415A can discharge electrostatic electricity on the second power supply Vcc 403.

In an alternative embodiment, the fourth transistor 415 includes a NMOS transistor, the seventh terminal includes a drain, the eighth terminal includes a gate and the ninth terminal includes a source. That is to say, as shown in FIG. 4B, the fourth transistor 415 comprises a NMOS transistor 415B having a drain connected to the second power supply Vcc 403, a gate connected to the second ground 404 via the third resistor 416, and a source connected to the second ground 404, such that the NMOS transistor 415B can discharge electrostatic electricity on the second power supply Vcc 403.

Alternatively, the circuit 40 further comprises two inverted connected fifth and sixth diodes 417,418 between the first power supply Vcc 400 and the second power supply Vcc 403. Sometimes one power supply may cause interference to another, therefore the two diodes 417 and 418 are used to isolate the two power supplies from each other, as well as to provide a channel for discharging electrostatic electricity from the first power supplier to the second power supplier, and vice versa.

Alternatively, the circuit 40 may further comprise two inverted connected seventh and eighth diodes 419 and 420 between the first ground 401 and the second ground 404. Sometimes one ground may cause interference to another, therefore the two diodes 419 and 420 are used to isolate the two grounds from each other, as well as to provide channel for discharging electrostatic electricity from the first ground to the second ground, and vice versa.

It should be appreciated by those skilled in the art that components from different embodiments may be combined to yield another technical solution. This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A circuit comprising an electrostatic discharge (ESD) protection device and a power amplifier, the power amplifier having an output port including a collector of a first transistor, wherein the ESD protection device comprises:
a second transistor having a first terminal connected to the collector of the first transistor, a second terminal connected to ground via a resistor, and a third terminal connected to the ground, such that the second transistor can discharge electrostatic electricity on the output port.

2. The circuit of claim 1, wherein the second transistor includes a NPN Bi-Polar transistor, the first terminal includes a collector, the second terminal includes a base and the third terminal includes an emitter.

3. The circuit of claim 1, wherein the second transistor includes a NMOS transistor, the first terminal includes a drain, the second terminal includes a gate and the third terminal includes a source.

4. The circuit of claim 1, wherein value of the resistor is between about 2 kΩ to about 100 kΩ.

5. A method of electrostatic discharge (ESD) protection for a power amplifier, the power amplifier having an output port including a first transistor, the first transistor having a base, a collector and an emitter, wherein the method comprises:
providing a second transistor having a first terminal connected to the collector of the first transistor, a second terminal connected to ground via a resistor, and a third terminal connected to the ground,
discharging electrostatic electricity on the output port with the second transistor.

6. A circuit with electrostatic discharge (ESD) protection, the circuit having a power amplifier input port and a power amplifier output port including a collector of a first transistor, wherein:
the circuit comprises a first power supply and a first ground for providing power to the power amplifier input port, and a second power supply and a second ground for providing power to the power amplifier output port, wherein
the circuit further comprises a second transistor having a first terminal connected to the collector of the first transistor, a second terminal connected to the second ground via a first resistor, and a third terminal connected to the second ground, such that the second transistor can discharge electrostatic electricity on the output port.

7. The circuit of claim 6, wherein the second transistor includes a NPN Bi-Polar transistor, the first terminal includes a collector, the second terminal includes a base and the third terminal includes an emitter.

8. The circuit of claim 6, wherein the second transistor includes a NMOS transistor, the first terminal includes a drain, the second terminal is a gate and the third terminal is a source.

9. The circuit of claim 6, further comprising a first diode connected between the power amplifier input port and the first ground, and a second diode connected between the power amplifier input port and the first power supply.

10. The circuit of claim 6, further comprising a third diode connected between the first power supply and the first ground, and a third transistor with a fourth terminal connected to the first power supply, a fifth terminal connected to the first ground via a second resistor, and a sixth terminal connected to the first ground.

11. The circuit of claim 10, wherein the third transistor includes a NPN Bi-Polar transistor, the fourth terminal includes a collector, the fifth terminal includes a base and the sixth terminal includes an emitter.

12. The circuit of claim 10, wherein the third transistor includes a NMOS transistor, the fourth terminal includes a drain, the fifth terminal includes a gate and the sixth terminal includes a source.

13. The circuit of claim 10, wherein value of the second resistor is between about 2 kΩ to about 100 kΩ.

14. The circuit of claim 6, further comprising a fourth diode connected between the second power supply and the second ground, and a fourth transistor with a seventh terminal connected to the second power supply, an eighth terminal connected to the second ground via a third resistor, and a ninth terminal connected to the second ground.

15. The circuit of claim 14, wherein the fourth transistor includes a NPN Bi-Polar transistor, the fourth terminal includes a collector, the fifth terminal includes a base and the sixth terminal includes an emitter.

16. The circuit of claim 14, wherein the fourth transistor includes a NMOS transistor, the fourth terminal includes a drain, the fifth terminal includes a gate and the sixth terminal includes a source.

17. The circuit of claim 14, wherein value of the third resistor is between about 2 kΩ to about 100 kΩ.

18. The circuit of claim 6, further comprising two inverted connected fifth and sixth diodes between the first power supply and the second power supply.

19. The circuit of claim 6, further comprising two inverted connected seventh and eighth diodes between the first ground and the second ground.
